(19) United States
(12) Patent Application Publication
(10) Pub. No.: US 2010/0212977 A1
(43) Pub. Date: Aug. 26, 2010

(54) REFORMER FOR A FUEL CELL SYSTEM AND METHOD FOR OPERATING SAID REFORMER

(75) Inventors: Matthias Boltze, Wulkenzin (OT Neuendorf) (DE); Michael Rozumek, Neubrandenburg (DE); Stefan Käding, Zerrenthin (DE); Manfred Pfalzgraf, Herrsching (DE); Andreas Engl, Munich (DE); Beate Bleeker, Munich (DE); Michael Süssl, Munich (DE); Markus Bedenbecker, Gauting (DE)

Correspondence Address: DICKINSON WRIGHT PLLC, 1875 Eye Street, NW, Suite 1200, WASHINGTON, DC, 20006, US

(73) Assignee: ENERDAY GMBH, Stockdorf (DE)

(21) Appl. No.: 12/305,783

(22) PCT Filed: Jun. 19, 2007
(86) PCT No.: PCT/DE2007/001080

§ 371 Date: May 4, 2010

(30) Foreign Application Priority Data
Jul. 13, 2006 (DE) 10 2006 032 469.2

(51) Int. Cl. H01M 8/06; B60K 1/00; B60K 1/04

(52) U.S. Cl. 180/65.31; 429/423

(57) ABSTRACT

The invention relates to a reformer (12) for a fuel cell system (10). Said reformer comprises an oxidation zone (48) to which stored fuel can be supplied by means of a primary fuel supply device (50; 62) for reaction with an oxidant; and a mixing zone (54), arranged downstream of the oxidation zone (48), to which stored fuel can be supplied by means of a secondary fuel supply device (56; 64) for mixing with substances originating from the oxidation zone (48). The invention is characterized in that the primary fuel supply device (50; 62) and the secondary fuel supply device (56; 64) are adapted to supply fuel in such a manner that the fuel supplied by the primary fuel supply device (50; 62) differs from the fuel supplied by the secondary fuel supply device (56; 64) with respect to the type of fuel and/or its state of aggregation and/or the pressure and/or the temperature at which it is supplied. The invention also relates to a fuel cell system comprising said reformer, to a motor vehicle comprising said fuel cell system and to a method for operating said reformer (12).

The invention relates to a reformer for a fuel cell system comprising an oxidation zone receiving a supply of tanked fuel by means of a primary fuel feeder for reacting with the oxidant; and arranged downstream of the oxidation zone a mixing zone receiving a supply of tanked fuel by means of a secondary fuel feeder for mixing with the substances emerging from the oxidation zone.

In addition, the invention relates to a fuel cell system comprising one such reformer and it also relates to a motor vehicle comprising one such fuel cell system.

Furthermore, the invention relates to a method for operating a reformer of a fuel cell system comprising the steps: feeding fuel from a fuel tank to an oxidation zone in which the fuel is reacted with oxidant; and feeding fuel from a fuel tank to a mixing zone arranged downstream of the oxidation zone, the fuel being mixable in the mixing zone with substances emerging from the oxidation zone.

Fuel cell systems serve to convert chemical energy into electrical energy. The central element of such systems is a fuel cell in which electrical energy is liberated by the controlled reaction of hydrogen and oxygen. Fuel cell systems must be capable of processing fuels as usual in practice. Since hydrogen and oxygen are reacted in a fuel cell, the fuel used must be conditioned so that the gas supplied to the anode of the fuel cell has a high percentage of hydrogen—this is the task of the reformer. For this purpose a reformer receives a supply of fuel and oxidant, preferably air, the fuel then being reacted with the oxidant in the reformer. The reformate generated by the reformer is fed to the fuel cell respectively a fuel cell stack resulting in electrical energy being liberated by the controlled reaction of hydrogen as a component of the reformate and oxidant. One generic reformer is known from German patent DE 103 59 205 A1.

The object of the present invention is to sophisticate the generic reformer, the generic fuel cell system, the generic motor vehicle and the generic method for operating a reformer such that an optimized operation of the reformer is now achievable.

This object is achieved by the independent claims.

Advantageous aspects and further embodiments of the invention read from the dependent claims.

The reformer in accordance with the invention is based on generic prior art in that the primary fuel feeder and secondary fuel feeder are engineered to supply fuel such that the fuel supplied by the primary fuel feeder differs from the fuel supplied by the secondary fuel feeder as regards grade and/or state of aggregate and/or feed pressure and/or feed temperature, the invention being based on having discovered that the requirements on the quality of evaporation differ in the oxidation zone and in the mixing zone. In the oxidation zone it is sufficient when the fuel evaporates so well that the resulting combustion is homogenous and accordingly a homogenous gas mixture enters the mixing zone, whereas, in the mixing zone the requirements on evaporation are higher. Here it has to be assured that a homogenous evaporation is achieved and at the same time the fuel vapor must mix homogenously with the gas mixture coming from the oxidation zone. This is achieved to advantage by the present invention in that the fuel supplied by the primary fuel feeder differs from the fuel supplied by the secondary fuel feeder as regards grade and/or state of aggregate and/or feed pressure and/or feed temperature with the advantage over prior art that these parameters can now be selected and adapted to result in optimum starting conditions for the evaporation in the corresponding zone, this with the further advantage that the performance modularity, i.e. the working range of the reformer is wider since the reformer can now be operated improved. This means in practice that a fuel of one grade (for instance diesel) can now be combustioned in the oxidation zone of the reformer whilst fuel of another grade (e.g. gasoline) can be admixed in the mixing zone as educt for reforming into the product gas from the oxidation zone combustion.

The reformer in accordance with the invention can be sophisticated to advantage in that the primary fuel feeder is a low pressure feeder with a feed pressure of max. 10 bar and the secondary fuel feeder is a high pressure feeder with a feed pressure of 50 bar and more. Due to the requirements on evaporation being higher in the mixing zone, making use of a costly high pressure feeder is of advantage. In the oxidation zone, by contrast, it is sufficient to use a lower cost low pressure feeder. In addition to energy savings this would likewise have the advantage that costs can be saved by eliminating a significantly more costly high pressure feeder for the oxidation zone.

It is in this case particularly provided for that the secondary fuel feeder is a high pressure feeder with a feed pressure of 50 to 100 bar.

As an alternative, it can be provided for that the secondary fuel feeder is a high pressure feeder with a feed pressure of 900 to 1100 bar.

Furthermore, the reformer in accordance with the invention may be sophisticated in that the primary fuel feeder is engineered to be connected to a first fuel tank and the secondary fuel feeder is engineered to be connected to a separate second fuel tank. Because of the different temperatures, enthalpies and speeds of evaporation of the various grades of fuel by supplying the oxidation zone and the mixing zone with different grades of fuel, each grade can now be selected so that in the corresponding zone evaporation and the associated reaction is optimized.

In addition, the invention provides a fuel cell system and a motor vehicle comprising such a fuel cell system incorporating the aforementioned advantages.

The generic method can be sophisticated to advantage in that the fuel supplied to the oxidation zone differs from the fuel supplied to the mixing zone as regards grade and/or state of aggregate and/or feed pressure and/or feed temperature. It is also in the scope of the method in accordance with the invention that the invention is based on having discovered that the requirements on the quality of evaporation in the oxidation zone differ from those in the mixing zone. In the oxidation zone it is sufficient when the fuel evaporates so well that combustion is homogenous and the gas mixture entering the mixing zone is correspondingly homogenous, whereas in the mixing zone the requirements on the evaporation are higher. Here, a homogenous evaporation is required and simultaneously the fuel vapor needs to mix with the gas mixture from the oxidation zone homogenously. This is achieved to advantage by the present invention in that the fuel supplied by the primary fuel feeder differs for the fuel supplied by the secondary fuel feeder as regards grade and/or state of aggregate and/or feed pressure and/or feed temperature with the advantage, over prior art, that these parameters can now be selected and adapted to result in optimum starting conditions for the evaporation in the corresponding zone, this with the further advantage that the performance modularity, i.e. the working range of the reformer is wider since the reformer can now be operated improved. This means in practice that a fuel of one grade (for instance diesel) can now be combustioned in the oxidation zone of the reformer whilst fuel of another grade (e.g. gasoline) can be admixed in the mixing zone as educt for reforming into the product gas from the oxidation zone combustion.

Furthermore, the method in accordance with the invention can be sophisticated to advantage in that the fuel is supplied to the oxidation zone with a feed pressure of max. 10 bar and the fuel supplied to the mixing zone has a feed pressure of 50 bar and more.

In particular it is thereby provided for that the fuel supplied to the mixing zone has a feed pressure of 50 to 100 bar.

As an alternative, it can be provided for that the fuel supplied to the mixing zone has a feed pressure of 900 to 1100 bar.

Furthermore, the method in accordance with the invention may be sophisticated by the fuel supplied to the oxidation zone being supplied from a first fuel tank and the fuel supplied to the mixing zone being supplied from a separate second fuel tank. Because of the different temperatures, enthalpies and speeds of evaporation of the various grades of fuel by supplying the oxidation zone and the mixing zone with different grades of fuel, each grade can now be selected so that in the corresponding zone evaporation and the associated reaction is optimized.

Preferred embodiments of the invention will now be detailed with reference to the attached drawings by way of example, in which:

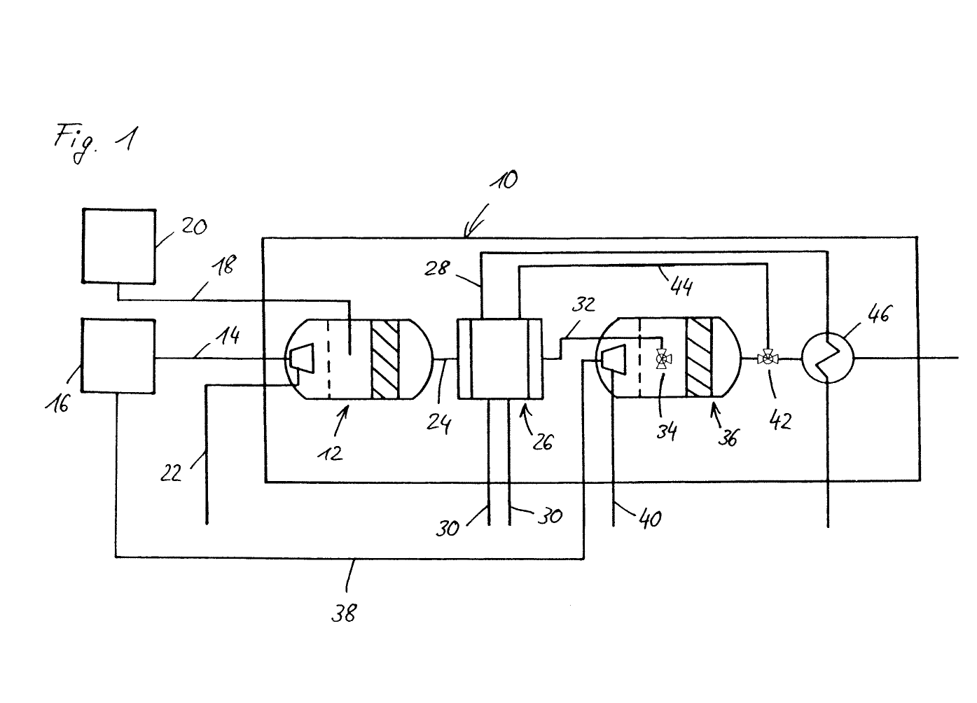

FIG. 1 is a diagrammatic representation of a fuel cell system in accordance with a first example embodiment;

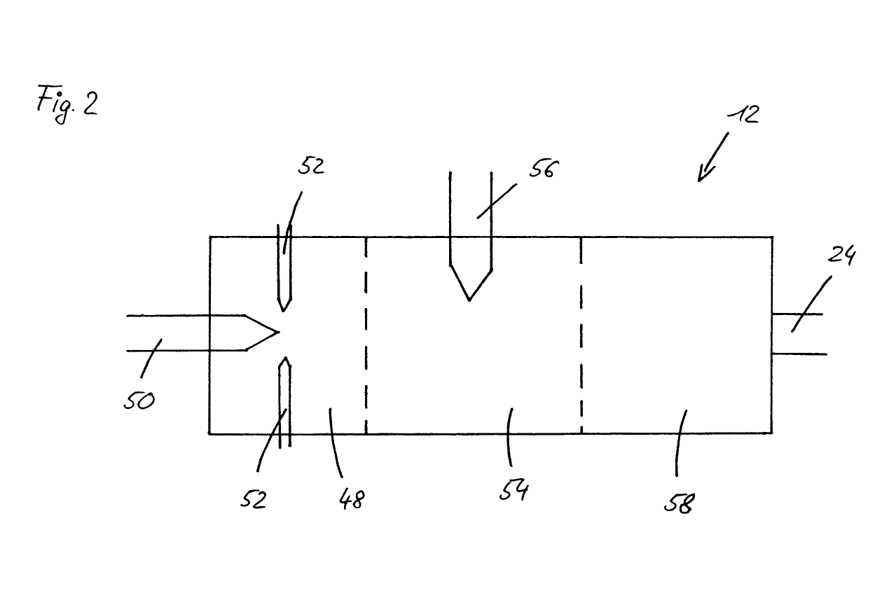

FIG. 2 is a diagrammatic representation of a reformer in accordance with a first example embodiment;

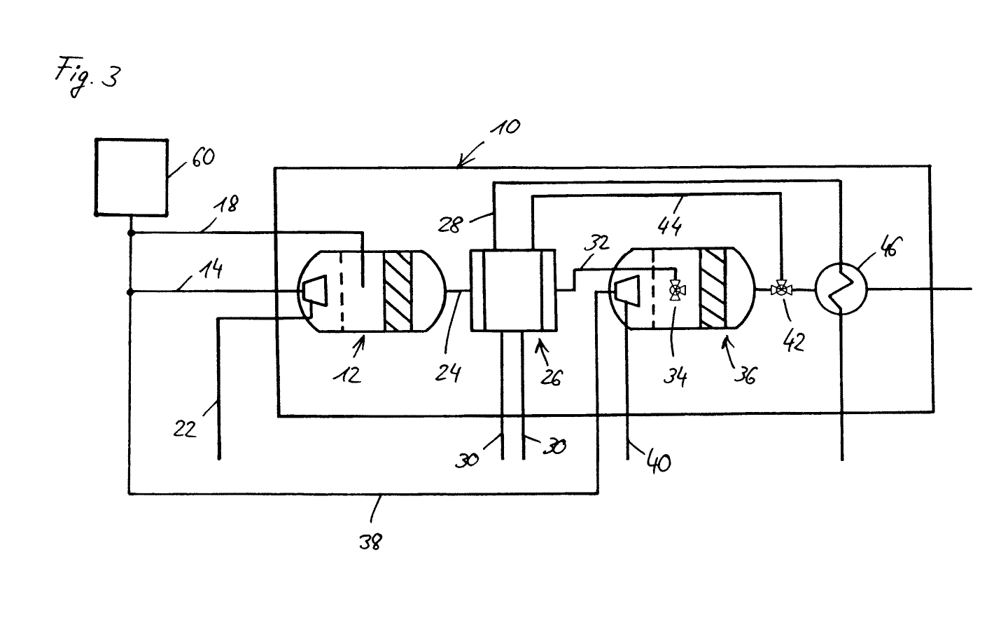

FIG. 3 is a diagrammatic representation of a fuel cell system in accordance with a second example embodiment;

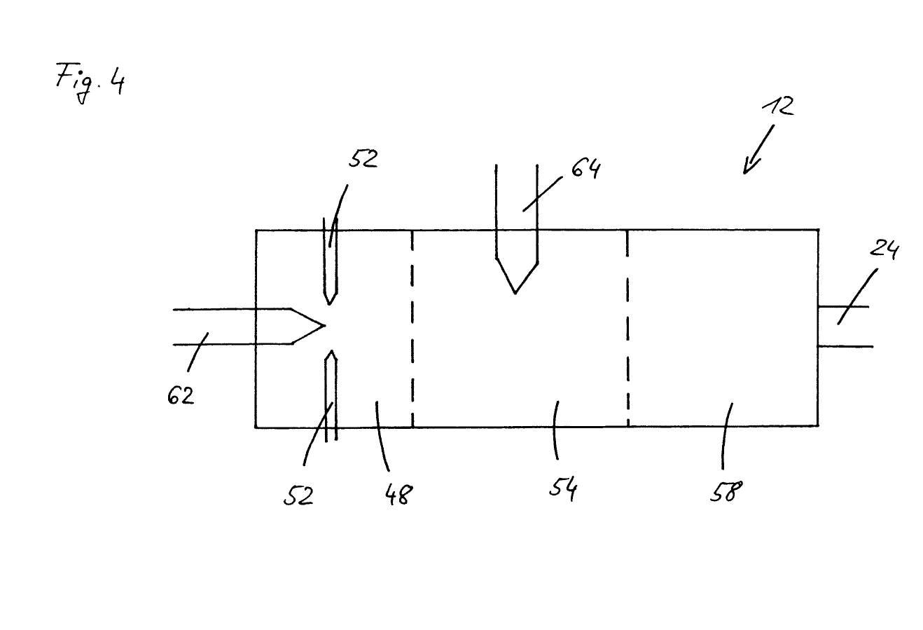

FIG. 4 is a diagrammatic representation of a reformer in accordance with a second example embodiment.

Referring now to FIG. 1 there is illustrated a diagrammatic representation of a fuel cell system in accordance with a first example embodiment. The fuel cell system 10 installed in a motor vehicle comprises a reformer 12 receiving a supply of fuel via a first fuel line 14 from a first fuel tank 16. Furthermore, the reformer 12 receives a supply of fuel via a second fuel line 18 from a second fuel tank 20. Suitable grades of fuel are diesel, gasoline, biogas, natural gas and further grades of fuel known from prior art. In the scope of the first example embodiment the grade of fuel in the first fuel tank 16 differs from that in the second fuel tank 20, it thus being of advantage to tank diesel in the first fuel tank 16 and gasoline in the second fuel tank 20. Furthermore, oxidant, for example air, is supplied to the reformer 12 via a first oxidant line 22. The reformate generated by the reformer 12 is supplied via a reformate line 24 to a fuel cell stack 26. The reformate concerned is a hydrogen-rich gas which is reacted in the fuel cell stack 26 with the aid of cathode feed air furnished via a cathode feed air line 28 in generating electricity and heat. The electricity generated can be picked off via electric terminals 30. In the case as shown, the anode exhaust gas is supplied via an anode exhaust gas line 32 to a mixer 34 of an afterburner 36. The afterburner 36 receives a supply of fuel from the first fuel tank 16 via a third fuel line 38. Furthermore, the afterburner 36 receives a supply of oxidant via a second oxidant line 40. In the afterburner 36 the depleted anode exhaust gas is reacted with the supply of fuel and oxidant into a combustion exhaust gas which is mixed with the cathode exhaust gas in a mixer 42 furnished via a cathode exhaust gas line 44 from the fuel cell stack 26 to the mixer 42. The combustion exhaust gas, which contains near zero noxious emissions, streams through the heat exchanger 46 to preheat the cathode feed air before finally leaving the fuel cell system 10.

Referring now to FIG. 2 there is illustrated a diagrammatic representation of the reformer in accordance with a first example embodiment. The reformer 12 comprises an oxidation zone 48 receiving a supply of fuel from a primary fuel feeder 50. The primary fuel feeder 50 is connected to the first fuel line 14 so that the primary fuel feeder 50 supplies the grade of fuel as tanked in the first fuel tank 16. In addition, connected to the first oxidant line 22 an oxidant feeder 52 is provided by means of which oxidant is feedable to the oxidation zone 48. Within the oxidation zone 48 reaction of fuel and oxidant occurs in a combustion or exothermic full oxidation reaction. The resulting hot product gas then enters the mixing zone 54 downstream, i.e. as shown on the right in FIG. 2. The individual zones of the reformer are represented defined separate from each other by broken lines in FIG. 2. The zones may be separated from each other by structural features or interface flowingly. In the mixing zone 54 the resulting product gas is admixed with additional gas by means of a secondary fuel feeder 56. In the present example the primary fuel feeder 50 and secondary fuel feeder 56 each comprise an injector and preferably a Venturi nozzle. It is just as possible, however, that the fuel is supplied by means of a evaporation type fuel feeder comprising a porous evaporator to the oxidation zone 48 and mixing zone 54 respectively. The secondary fuel feeder 56 is connected to the second fuel line 18 so that fuel tanked in the second fuel tank 20 can be supplied to the secondary fuel feeder 56 by a fuel supply other than that from the first fuel tank 16. In addition it may be provided for that the mixing zone 54 receives a supply of oxidant. The gas mixture mixed with the additional fuel enters a reforming zone 58 where it is reacted in an endothermic reaction into a hydrogen rich gas mixture, preferably by means of a catalyst sited therein. This reformate, i.e. hydrogen rich gas, mixture leaves the reformer 12 via the reformate line 24 where it is available for further use in the fuel cell stack 26.

In one variant of the first example embodiment fuel is tanked of the same grade in the first fuel tank 16 and second fuel tank 20, but which differs as to its state of aggregate (i.e. gaseous, liquid). In this arrangement, for example, a certain fuel may be tanked in one tank liquid and fuel of the same grade may be tanked gaseous in another tank, achieved by a higher pressure existing both in the one tank and its corresponding fuel line than in the other fuel line, maintaining the fuel in a gaseous condition.

It is to be noted that reference numerals used as follows identify like elements having the same functionality as in the first example embodiment, whose description is omitted to avoid tedious repetition.

Referring now to FIG. 3 there is illustrated a diagrammatic representation of a fuel cell system in accordance with a second example embodiment. The fuel cell system 10 of the second example embodiment differs from the fuel cell system as shown in FIG. 1 by instead of the first fuel tank 16 and second fuel tank 20 only a single fuel tank 60 is installed in the motor vehicle. This fuel tank 60 supplies the first, second and third fuel line 14, 18, 38 with fuel of the same grade.

Referring now to FIG. 4 there is illustrated a diagrammatic representation of a reformer in accordance with the second example embodiment. The reformer 12 of the second example embodiment comprises instead of the primary fuel feeder as shown in FIG. 2 a primary fuel feeder 62 configured as a low pressure feeder system. Preferably, the primary fuel feeder 62 is a low pressure injector with a single grade nozzle, but it may also be a fuel feeder of the evaporation type, comprising a porous evaporator, for example of the evaporator fleece (metallic foam) type. The low pressure feeder system works with a feed pressure of up to 10 bar. Furthermore, the reformer 12 of the second example embodiment comprises a secondary fuel feeder 64 engineered as a high pressure system. The high pressure system is an injector system which is operated at 900 to 1100 bar and may be operated preferably at approx. 1000 bar, a pressure achievable, for example, with a common-rail system. As an alternative, the high pressure feeder system can be operated at a feed pressure of 50 to 100 bar, achievable for example by means of a surge pressure injector system.

In one variant of the second example embodiment the primary fuel feeder 62 is engineered as an injector and the secondary fuel feeder 64 as a fuel feeder of the evaporation type, comprising a porous evaporator, for example a metallic foam evaporator.

In a second variant of the second example embodiment the primary fuel feeder 62 and secondary fuel feeder 64 are engineered or operated such that the fuel supplied by the primary fuel feeder 62 in being fed into the corresponding zone of the reformer 12 has a different temperature to the fuel supplied by the secondary fuel feeder 64. As an alternative this different feed temperature of the fuel may also be achieved by means of a heater or cooler in the first fuel line 14 and/or second fuel line 18. This difference in temperature may also result in the fuel in the primary fuel feeder 62 being fed in a different state of aggregate than in the secondary fuel feeder 64.

It is to be explicitly noted that although the individual example embodiments and their variants are described separate by way of the corresponding FIGs., all and any combinations of the various example embodiments and their variants is within the scope of the invention. For example, it is just as possible to combine the first and second example embodiments in which differing grades of fuel are supplied to a reformer comprising a high and low pressure fuel feeder.

Although not explicitly shown in the FIGs. as described, corresponding delivery means such as for example pumps or blowers and/or control valves may be provided in the fuel lines 14, 18 and 38, in the oxidant lines 22 and 40 as well as in the cathode feed air line 28.

It is understood that the features of the invention as disclosed in the above description, in the drawings and as claimed may be essential to achieving the invention both by themselves or in any combination.

### LIST OF REFERENCE NUMERALS

10 fuel cell system
12 reformer
14 first fuel line
16 first fuel tank
18 second fuel line
20 second fuel tank
22 first oxidant line
24 reformate line
26 fuel cell stack
28 cathode feed air line
30 electric terminals
32 anode exhaust gas line
34 mixer
36 afterburner
38 third fuel line
40 second oxidant line
42 mixer
44 cathode exhaust air line
46 heat exchanger
48 oxidation zone
50 primary fuel feeder
52 oxidant feeder
54 mixing zone
56 secondary fuel feeder
58 reforming zone
60 fuel tank
62 primary fuel feeder
64 secondary fuel feeder

1. A reformer for a fuel cell system comprising
an oxidation zone receiving a supply of tanked fuel by means of a primary fuel feeder for reacting with the oxidant; and
arranged downstream of the oxidation zone a mixing zone receiving a supply of tanked fuel by means of a secondary fuel feeder for mixing with the substances emerging from the oxidation zone,
wherein the primary fuel feeder and secondary fuel feeder are engineered to supply fuel such that the fuel supplied by the primary fuel feeder differs from the fuel supplied by the secondary fuel feeder as regards grade and/or state of aggregate and/or feed pressure and/or feed temperature.

2. The reformer of claim 1, wherein the primary fuel feeder is a low pressure feeder with a feed pressure of max. 10 bar and the secondary fuel feeder is a high pressure feeder with a feed pressure of 50 bar and more.

3. The reformer of claim 2, wherein the secondary fuel feeder is a high pressure feeder with a feed pressure of 50 to 100 bar.

4. The reformer of claim 2, wherein the secondary fuel feeder is a high pressure feeder with a feed pressure of 900 to 1100 bar.

5. The reformer of claim 1, wherein the primary fuel feeder is engineered to be connected to a first fuel tank and the secondary fuel feeder is engineered to be connected to a separate second fuel tank.

6. A fuel cell system comprising the reformer of claim 1.

7. A motor vehicle comprising the fuel cell system of claim 6.

8. The motor vehicle of claim 7, further comprising two fuel tanks, one of the fuel tanks being connected to the primary fuel feeder of the reformer and the second fuel tank is connected to the secondary fuel feeder.

9. A method for operating a reformer of a fuel cell system comprising the steps:
feeding fuel from a fuel tank to an oxidation zone in which the fuel is reacted with oxidant; and
feeding fuel from a fuel tank to a mixing zone arranged downstream of the oxidation zone, the fuel being mixable in the mixing zone with substances emerging from the oxidation zone,
wherein the fuel supplied to the oxidation zone differs from the fuel supplied to the mixing zone as regards grade and/or state of aggregate and/or feed pressure and/or feed temperature.

10. The method of claim 9, wherein the fuel is supplied to the oxidation zone with a feed pressure of max. 10 bar and the fuel supplied to the mixing zone has a feed pressure of 50 bar and more.

11. The method of claim 10, wherein the fuel supplied to the mixing zone is supplied with a feed pressure of 50 to 100 bar.

12. The method of claim 10, wherein the fuel supplied to the mixing zone is supplied with a feed pressure of 900 to 1100 bar.

13. The method of claim 9, wherein the fuel supplied to the oxidation zone is supplied from a first fuel tank and the fuel supplied to the mixing zone is supplied from a separate second fuel tank.
